(19) United States
(12) Patent Application Publication
(10) Pub. No.: US 2026/0062966 A1
(43) Pub. Date: Mar. 5, 2026

(54) ADAPTIVE CINCH CALIBRATION SYSTEM AND METHOD

(71) Applicant: Magna Closures Inc.

(72) Inventors: Joseph OSMIALOWSKI, Newmarket (CA); Rakesh RAMAMOORTHY, Newmarket (CA)

(21) Appl. No.: 19/319,159

(22) Filed: Sep. 4, 2025

Related U.S. Application Data
(60) Provisional application No. 63/690,924, filed on Sep. 5, 2024.

(51) Int. Cl. E05B 81/20; E05B 81/06; E05B 81/56; E05B 81/66

(52) U.S. Cl. CPC E05B 81/21; E05B 81/06; E05B 81/56; E05B 81/66

(57) ABSTRACT

A system for calibrating a cinch operation of a latch system coupled to a closure panel of a vehicle, the system comprising: an actuator for moving the closure panel from a partially closed position to a closed position using a series of applied forces; one or more sensors for sensing positions of a ratchet of the latch system in response to each of the series of applied forces, said each of the series of applied forces provided in a respective zone of a series of zones; and a controller for determining a respective speed of the ratchet in each of the respective zones based on the sensed positions and for comparing each of the respective speeds to a set of calibration data containing one or more predetermined speeds of the ratchet for each of the respective zones of the series of zones; wherein based on said comparing, the controller adjusts one or more of the series of applied forces in order to adjust one or more of the respective speeds of the ratchet.

### FIELD OF THE INVENTION

This present invention relates to latch operation for vehicle closure panels.

### BACKGROUND

A typical motor vehicle door is mounted in a door frame on the vehicle and is movable between open and closed positions. Usually the door is held in a closed position by the latching engagement between a spring-biased ratchet pivotally mounted inside the door latch and a U-shaped striker secured to the door frame. The ratchet is most often spring-biased toward the unlatched position to release the striker and is maintained in the latched position to hold the striker by a spring-biased pawl or other mechanical structure. The ratchet cannot pivot to release the striker until the pawl is moved.

It is often difficult, however, to completely close and latch manually latching vehicle doors on current model vehicles because the desire to reduce vehicle weight and to improve fuel economy has led engineers to design vehicles with relatively thin and lightweight doors. Often relatively hard door seals are used with these thin, lightweight doors to improve sealing around the door, particularly at high driving speeds. Because many vehicle doors are relatively lightweight and have relatively hard door seals, many vehicles doors often have insufficient internal energy when pushed closed to compress these hard door seals and fully pivot the ratchet to the latched position to latch the door.

Power assisted door latch assemblies have been developed to overcome the problems associated with latching doors with lightweight construction and hard door seals. Power assisted door latch assemblies allow low internal energy or soft closure of lightweight doors without the need to slam the door even with the increased seal pressure that results from relatively hard door seals.

Current problems exist with powered latch assemblies, including complicated latch component configurations and large and inconvenient assembly footprints. Further, when using a power cinching latch, it can be complicated to provide anti-pinch protection for a finger or foreign object during the cinching operation.

Further, it is recognized that door to door variation during manufacture can also cause cinching efforts to vary. This variation from door to door needs to be accounted for in respect of each different door/seal/latch combination, once or otherwise over the lifetime of the vehicle as vehicle components age/wear or are otherwise repaired/replaced. The variation can be caused by a multitude of different factors, such as but not limited to: striker misalignment, improper seal installation, door hinge misalignment, incorrect installation of inside trim panel, latch efficiency differences, etc. For example, throughout a vehicle's life, the amount of force required to cinch a door from secondary to primary position will vary. This can be due to many factors, such as but not limited to seal load change, temperature, vehicle inclination, latch grease, etc. These changes need to be accounted for during pinched detection, because not accounting for these changes can lead to over pinch of a finger or being unable to complete the cinch process in a repeatable and reliable manner. For example it is impossible to predict when a vehicle will be parked on an incline or if the user will drive from Alaska (hard seal) to California the next day (soft seal), which could drastically change the cinch operational behavior and thus the amount of cinch force required to perform the cinching operation of the latch at any point(s) in the cinch cycle.

### SUMMARY

It is an object to the present invention to provide a pinch detection system or method to obviate or mitigate at least one of the above-mentioned problems.

A first aspect provided is a system for calibrating a cinch operation of a latch system coupled to a closure panel of a vehicle, the system comprising: an actuator for moving the closure panel from a partially closed position to a closed position using a series of applied forces; one or more sensors for sensing positions of a ratchet of the latch system in response to each of the series of applied forces, said each of the series of applied forces provided in a respective zone of a series of zones; and a controller for determining a respective speed of the ratchet in each of the respective zones based on the sensed positions and for comparing each of the respective speeds to a set of calibration data containing one or more predetermined speeds of the ratchet for each of the respective zones of the series of zones; wherein based on said comparing, the controller adjusts one or more of the series of applied forces in order to adjust one or more of the respective speeds of the ratchet.

A second aspect provided is a method for calibrating a cinch operation of a latch system coupled to a closure panel of a vehicle, the method comprising the steps of: operating an actuator for moving the closure panel from a partially closed position to a closed position using a series of applied forces; receiving from one or more sensors a plurality of signals for sensing positions of a ratchet of the latch system in response to each of the series of applied forces, said each of the series of applied forces provided in a respective zone of a series of zones; determining a respective speed of the ratchet in each of the respective zones based on the sensed positions; comparing each of the respective speeds to a set of calibration data containing one or more predetermined speeds of the ratchet for each of the respective zones of the series of zones; and based on said comparing, adjusting one or more of the series of applied forces in order to adjust one or more of the respective speeds of the ratchet.

In accordance with another aspect, a latch having a ratchet retaining a striker coupled to a closure panel of a vehicle in a primary striker capture position and a secondary striker capture position, the latch adapted to move the ratchet using a motor during a cinch operation to move the striker from the secondary striker capture position, wherein the motion of the ratchet is monitored during the cinch operation and the motor is operated during a subsequent cinch operation based on the monitored motion of the ratchet during the cinch operation.

### BRIEF DESCRIPTION OF THE DRAWINGS

The foregoing and other aspects will be more readily appreciated having reference to the drawings, wherein:

FIG. 1a is a perspective view of an example vehicle;

FIG. 1b is a perspective view of a further example of a vehicle;

FIG. 1c is a perspective view of a further example of a vehicle;

FIG. 2 shows an example powered cinch latch mechanism in an unlatched configuration for the vehicle of FIG. 1a;

FIG. 3a, b, c shows details of operation of the mechanism of FIG. 2 for a pinch event;

FIG. 4 shows the powered cinch latch mechanism of FIG. 2 in a primary latch position;

FIG. 5 shows an alternative view of the powered cinch latch mechanism of FIG. 2 in a primary latch position;

FIG. 6 shows an alternative embodiment of the powered cinch latch mechanism of FIG. 2;

FIG. 7 shows an alternative embodiment of the cinched latch mechanism of FIG. 2 having a plurality of electronic motors;

FIG. 8 shows an example embodiment of the pinch detection system of the vehicle of FIG. 1a for the example latch configuration of FIG. 2;

FIG. 9 shows a further example embodiment of the cinch calibration system of the vehicle of FIG. 1a;

FIG. 10 shows a still further example embodiment of the cinch calibration system of the vehicle of FIG. 1a;

FIG. 11 shows a still further example embodiment of the cinch calibration system of the vehicle of FIG. 1a;

FIG. 12 shows a still further example embodiment of the cinch calibration system of the vehicle of FIG. 1a;

FIG. 13 shows a still further example embodiment of the cinch calibration system of the vehicle of FIG. 1a;

FIG. 14 shows an example flowchart of operation for the cinch calibration system of FIG. 8;

FIG. 15 shows a further example flowchart of operation for the cinch calibration system of FIG. 8;

FIG. 16 shows example calibration parameters for the cinch calibration system of FIG. 8; and

FIGS. 17-22 show further alternative example flowcharts of operation for the cinch calibration system of FIG. 8.

### DESCRIPTION

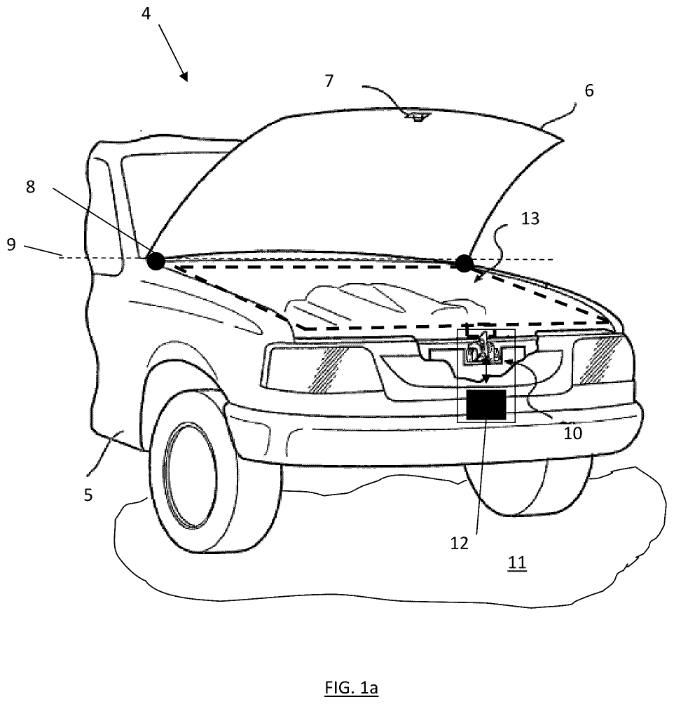

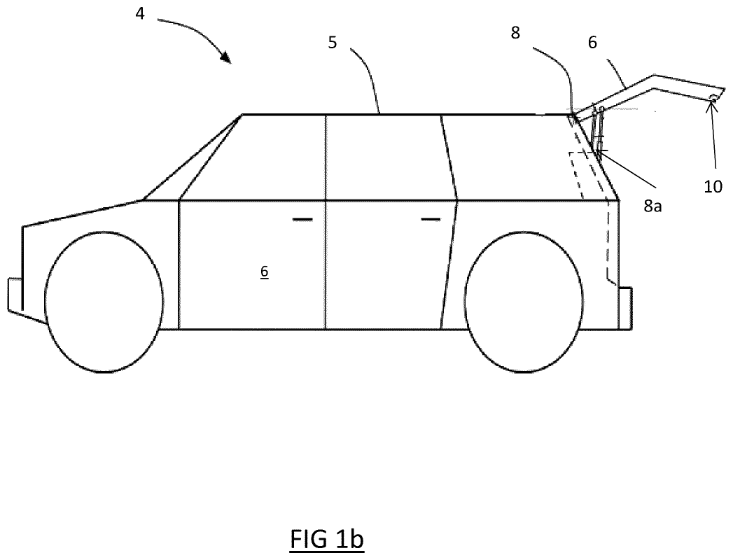

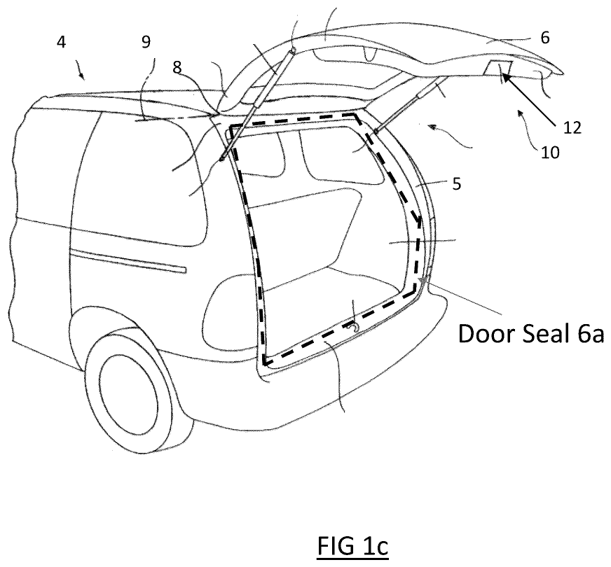

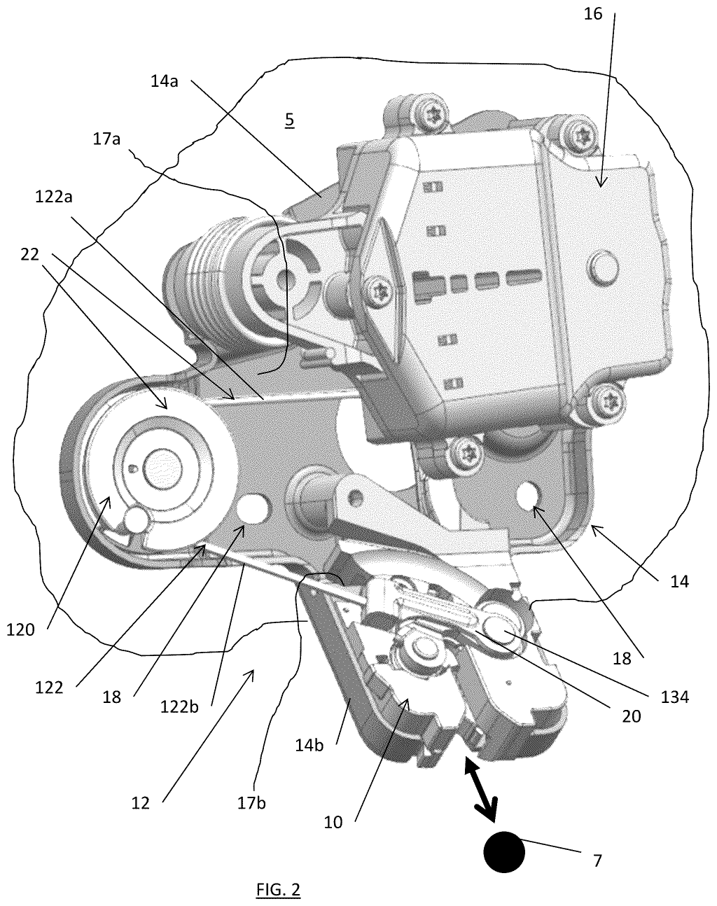

Referring to FIG. 1a, shown is a vehicle 4 with a vehicle body 5 having one or more closure panels 6 coupled to the vehicle body 5. The closure panel 6 is connected to the vehicle body 5 via one or more hinges 8 and a latch (assembly) 10 (e.g. for retaining the closure panel 6 in a closed position once closed). It is also recognized that the hinge 8 can be configured as a biased hinge 8 to bias the closure panel 6 towards an open position and/or towards the closed position. As such, the hinge 8 can also incorporate one or more actuated struts to assist in opening and closing of the closure panel 6, as desired. The closure panel 6 has a mating latch component 7 (e.g. striker) mounted thereon for coupling with the latch 10 mounted on the vehicle body 5. Alternatively, latch 10 can be mounted on the closure panel 6 and the mating latch component (striker) 7 mounted on the body 5 (not shown). For example, the latch 10 can have a ratchet 24 (see FIG. 2) for retaining a striker 7 between a striker releasing position corresponding to an open position of the closure panel 6 and a secondary striker capture position corresponding to a partially closed position (e.g. secondary position) of the closure panel 6. Further, the ratchet 24 can be configured for having a primary striker capture position corresponding to a fully closed position of the closure panel 6 (e.g. a latched or primary position).

Referring to FIG. 1b, shown is the vehicle 4 with the vehicle body 5 having an alternative embodiment of the one or more closure panels 6 coupled to the vehicle body 5, including one or more struts 8a (e.g. power actuated struts assembly 8a). The closure panel 6 is connected to the vehicle body 5 via one or more hinges 8 and latch 10 (e.g. for retaining the closure panel 6 in a closed position once closed). It is recognized that examples of the closure panel 6 can include a hood panel, a door panel, a hatch panel and other panels as desired.

The hinges 8 (and/or the struts 8a) can provide for movement of the closure panel 6 between a closed panel position (shown in dashed outline) and an open panel position (shown in solid outline), such that the hinges 8 can be involved during the movement of the closure panel 6 between the open panel position and the closed panel position, can be involved in driving the movement of the closure panel 6 towards the open panel position (e.g. as a biased hinge 8 or strut 8a), or can be involved in driving the movement of the closure panel 6 towards the closed panel position. In the embodiment shown, the closure panel 6 pivots between the open panel position and the closed panel position about a pivot axis 9 (e.g. of the hinge 8), which can be configured as horizontal or otherwise parallel to a support surface 11 of the vehicle 4. In other embodiments, the pivot axis 9 may have some other orientation such as vertical or otherwise extending at an angle outwards from the support surface 11 of the vehicle 4. In still other embodiments, the closure panel 6 may move in a manner other than pivoting, for example, the closure panel 6 may translate along a predefined track or may undergo a combination of translation and rotation between the open and closed panel positions, such that the hinge 8 includes both pivot and translational components (not shown). As can be appreciated, the closure panel 6 can be embodied, for example, as a hood, passenger door, or lift gate (otherwise referred to as a hatch) of the vehicle 4.

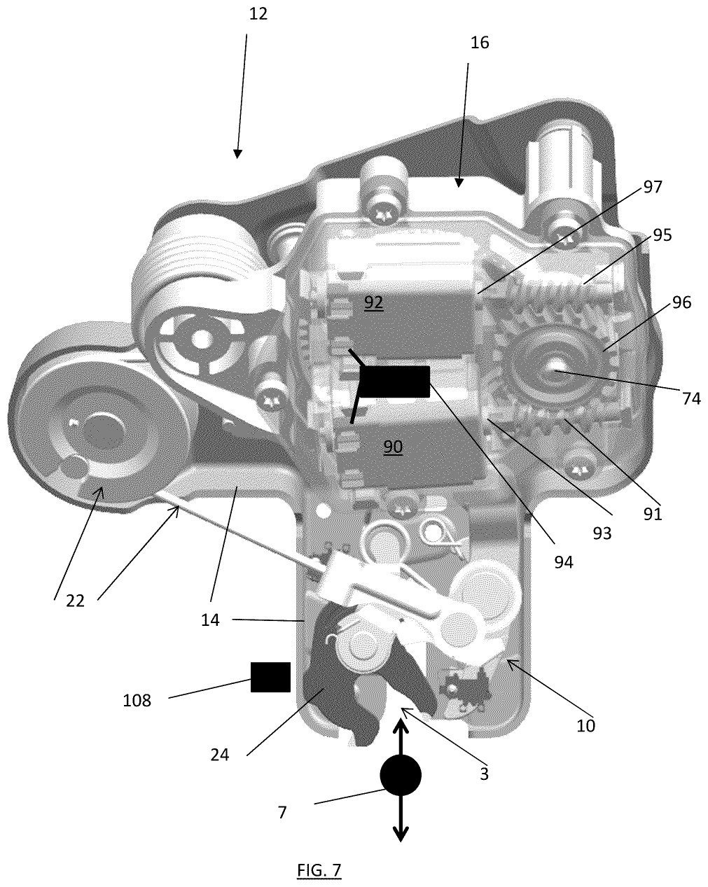

Also provided is a power latch system 12 (also referred to as latch system 12—see FIG. 2) coupled to the latch 10, as further described below. The power latch system 12 is configured for actuating the operation of the latch 10. In this manner, the power latch system 12 can be used to forcefully provide, during deployment, some form of force assisted open operation (e.g. full open, partial open, etc.) of the closure panel 6 and/or some form of force assisted close operation (e.g. full open, partial open, etc.) of the closure panel 6, for example as provided as a cinching operation in order to move the closure panel 6 to a fully closed position against close resistance induced by presence of door seals 6a, see FIG. 1c. As such, it is recognized that the compressible seals 6a (e.g. rubber) have an effect on the force the cinch actuator(s) 90, 92 (e.g. a component of the power latch system 12—see FIG. 7) needs to overcome during cinching.

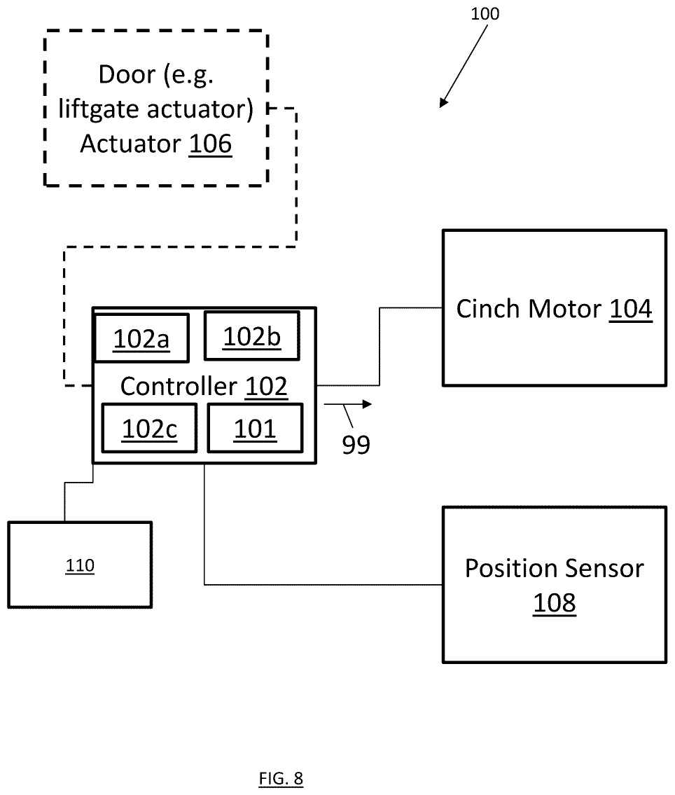

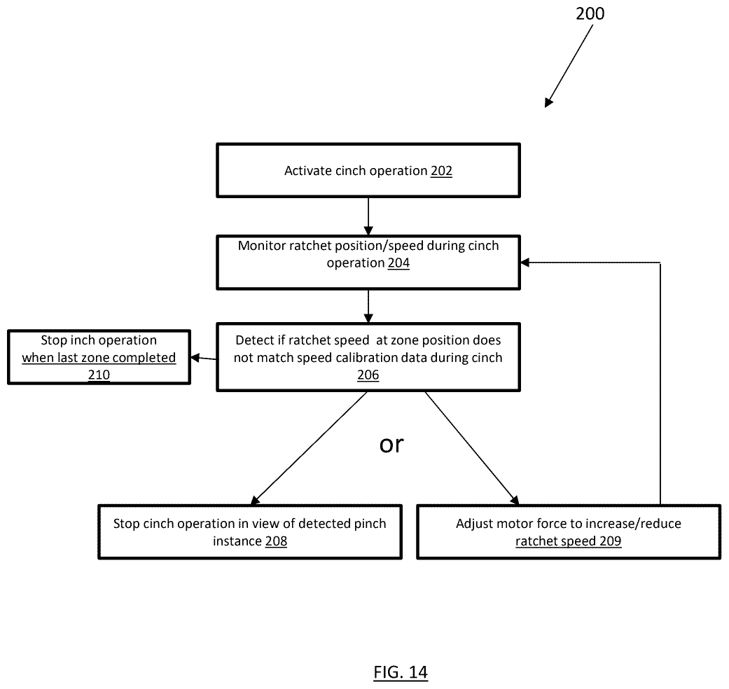

As further described below, a cinching calibration system 100 (see FIG. 8) incorporates a procedure/mode 200, 300, 400 (e.g. see FIGS. 14, 15 and 17-22) that uses a controller 102 along with a cinch motor 104 (e.g. cinch actuator 90,92-see FIG. 8) to determine the ratchet 24 speeds and corresponding appropriate motor 104 output forces in each of the predefined zones of the ratchet travel 24 during the cinch operation.

This cinching calibration procedure/mode 200, 300, 400 could be done at the OEM during a first cinch process, however, preferably this self-learn cinching calibration procedure/mode 200, 300, 400 could be run at specific instances throughout the vehicle 4 life. Here there can be a cinch calibration method 200, 300, 400 that occurs during the life of the latch system 12. For example, there can be a monitoring and an adjustment of cinch parameters by the cinching calibration system 100 during each cinch cycle performed by the latch system 12, or after some other predetermined period time and/or predetermined number of cinch cycles performed, as compared to only an initial calibration of the cinch at the assembly line.

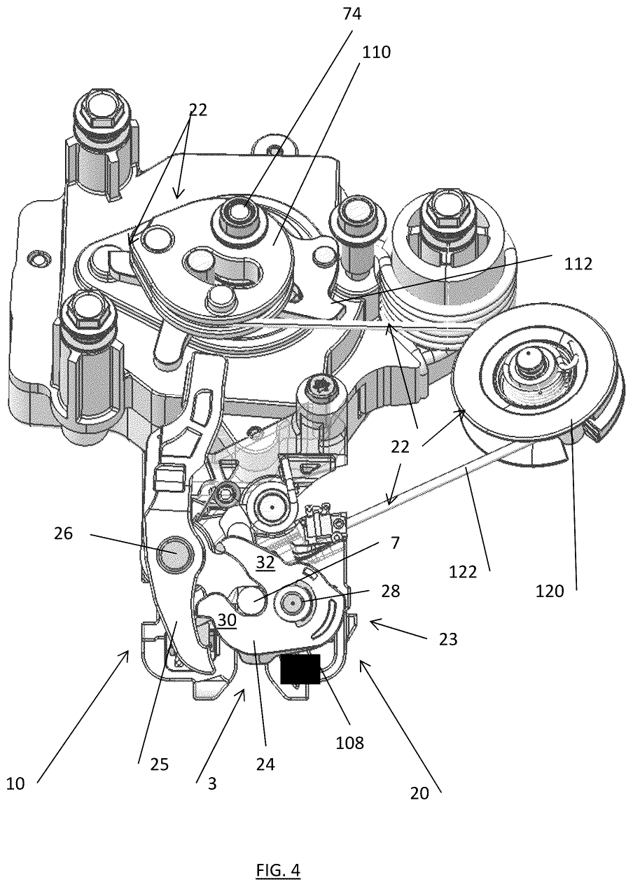

The method 200, 300, 400 can be configured to monitor ratchet 24 speed, which has been shown to be a good indicator of cinch force applied by the cinch motor 104 without having to monitor motor 104 current. A hall sensor 108 (e.g. a position sensor 108—see FIGS. 4,8) can be used for monitoring the absolute position of the ratchet 24 for this purpose to obtain the ratchet 24 speed, as monitored/calculated by the controller 102 during the cinching calibration method 200, 300, 400.

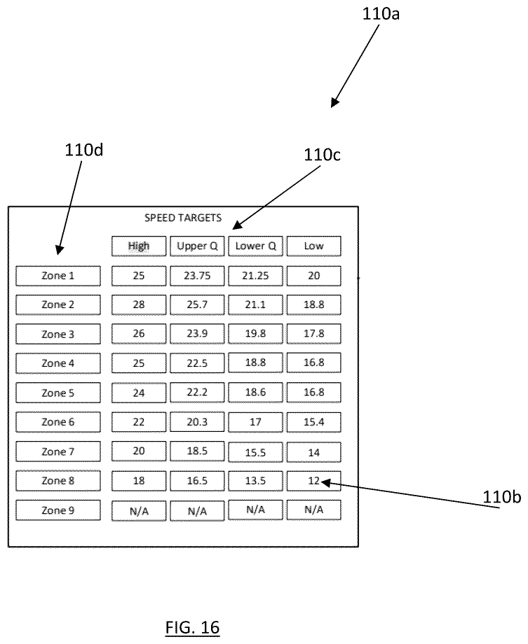

For example, referring to FIG. 8, the cinch motor 104 (e.g. actuator) force output targets can be adjusted to adapt to environmental variations (changes in seal 6a condition, changes in latch grease adding friction to the ratchet rotation, changes in the hinge friction etc.) over the life of the latch 12, and even between cinch cycles to adjust to the slightest changes in the system behavior. The motor 104 force output target adjustments can be made to specific zones (e.g. predefined portions of the ratchet 24 travel during the cinch operation—e.g. travel between the partially closed and fully closed positions of the latch 10) of the cinch latch travel, based on comparison to predetermined speed thresholds levels of the ratchet 24 within these zones, and adjustments can be made to the motor 104 force output after successful cinch cycles or failed cinched cycles (cinching stopped), in order to adjust the monitored ratchet 24 speed (i.e. the ratchet 24 speed calculated by the controller 102 based on position sensor 108 readings of the ratchet 24 travel during the cinching operation). For example, the cinch calibration system 100 for calibrating the cinch operation of the latch system 12 can involve controlling the actuator 104 using a series of applied forces (e.g. force outputs such as provided by operation of a stepper motor used as the actuator 104); receiving signals from one or more sensors 108 used to sense changing positions of the ratchet 24 in response to each of the series of applied forces, such that each of the series of applied forces is performed by the actuator 104 in a respective zone of a series of zones (see FIGS. 16a, 16b). In this manner, the controller 102 can determine a respective speed of the ratchet 24 in each of the respective zones based on the sensed positions and then compare each of the respective speeds (of the ratchet 24) to the set of calibration data 110 containing one or more predetermined speeds (e.g. a speed range) of the ratchet 24 for each of the respective zones of the series of zones. Based on the step of comparing, the controller 102 can adjust one or more of the series of applied forces (as output from the actuator 104) in order to adjust one or more of the respective speeds of the ratchet 24. The adjusted output forces can be stored in the set of calibration data 110 for use in subsequent cinch operations of the power latch system 12. In one possible embodiment, the step of comparing and adjusting one or more of the respective speeds of the ratchet 24 may occur for each cinch cycle so that the adjusted forces may be applied on the next cinch cycle.

As further described below for the cinching calibration procedure/mode 200, 300, 400, in essence the actuator 104 force output is matched to a determined ratchet 24 speed at a given ratchet 24 position (e.g. also as desired for measured door 6 position of other moving latch/vehicle component representative of the cinching operation) (applied sequentially in different zones towards the cinched position). Thus the controller 102 can determine whether the measure ratchet 24 speed for a particular applied motor 104 force is within predetermined speed settings at each of the predefined zones. If the ratchet 24 speed is outside of the predetermined speed settings, in any/all of the zones, then the motor 104 output force can be adjusted (e.g. decrease motor 104 force to decrease ratchet 24 speed or increase motor 104 force to increase ratchet 24 speed). The results of the calibration procedure 200, 300, 400 can be saved as calibration data 110, which can be saved in the controller 102 and used to modify the operation (e.g. force applied by the cinch actuator 104) in future cinch operations of the power latch system 12.

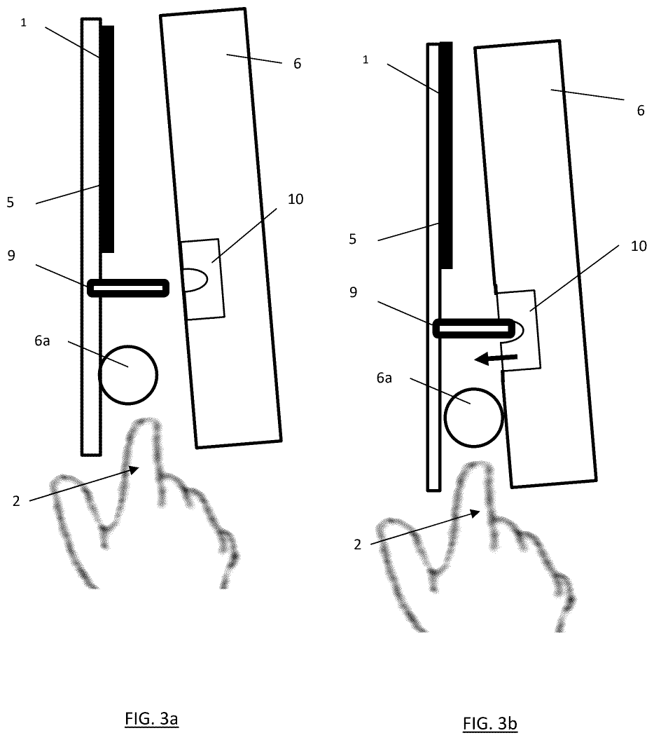

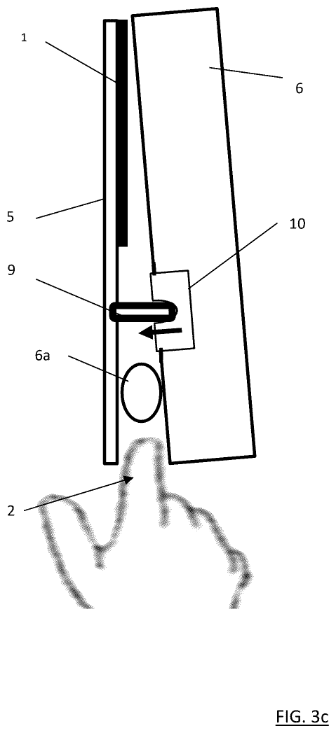

Referring to FIGS. 3a, 3b, 3c, shown is an example closure panel 6 moving in an open position (FIG. 3a where the striker 7 is not engaged with the latch 10), a partially closed position (FIG. 3b where the striker is engaged with the latch position) where the cinch function of the power latch system 12 has begun to activate, and a cinching operation (FIG. 3c where the closure panel 6 is closing using the cinch function of the actuator(s) 90, 92) such that closure panel 6 is moving using cinch actuation towards the cinched or primary closed position. It is recognized that during cinch the seal 6a would become incrementally compressed from the start to the end of the cinch operation. For example, FIG. 3a, b, c optionally show the presence of a foreign object 2 (e.g. obstacle) that could be present during the cinch calibration process, as further discussed below.

In particular, FIG. 3c shows how a pinch of a foreign object 2 (e.g. obstacle) can still occur between the door edge and the vehicle body during a cinch function. In particular, FIGS. 3a, 3b, 3c show how a pinch strip sensor 1 may not assist in detection of the foreign object 2 positioned nearer to the latch 10. Advantageously, the below described operation of the power latch 12 in conjunction with a cinch calibration system 100 (see FIG. 8). As further discussed below, operation of the cinch calibration system during the cinch operation of the latch 10 (as assisted by the power latch system 12) is to overcome seal 6a load, as seal 6a load in the presence of the amount of motor 104 force output will dictate the speed of the ratchet 24. For example, if the motor 104 force output exactly matches seal 6a load, then the ratchet speed 24 detected would be zero. Similarly, in the presence of an obstacle 2, the ratchet 24 speed would be slower or even stopped unexpectedly as the preexisting calibrated motor 104 force output would not be enough to overcome the presence of the obstacle 2 and thus continue to cinch the latch 10 as expected.

For vehicles 4 in general, the closure panel 6 can be referred to as a partition or door, typically hinged, but sometimes attached by other mechanisms such as tracks, in front of an opening 13 which can be used for entering and exiting the vehicle 4 interior by people and/or cargo. It is also recognized that the closure panel 6 can be used as an access panel for vehicle 4 systems such as engine compartments and also for traditional trunk compartments of automotive type vehicles 4. The closure panel 6 can be opened to provide access to opening, or closed to secure or otherwise restrict access to the opening 13. It is also recognized that there can be one or more intermediate open positions (e.g. unlatched position) of the closure panel 6 between a fully open panel position (e.g. unlatched position) and fully closed panel position (e.g. latched position), as provided at least in part by the hinges 8 and latch 10, as assisted by the power latch system 12. For example, the power latch system 12 can be used to provide an opening force (or torque) and/or a closing force (or torque) for the closure panel 6.

Movement of the closure panel 6 (e.g. between the open and closed panel positions) can be electronically and/or manually operated, where power assisted closure panels 6 can be found on minivans, high-end cars, or sport utility vehicles (SUVs) and the like. As such, it is recognized that movement of the closure panel 6 can be manual or power assisted during operation of the closure panel 6 at, for example: between fully closed (e.g. locked or latched) and fully open (e.g. unlocked or unlatched); between locked/latched and partially open (e.g. unlocked or unlatched); and/or between partially open (e.g. unlocked or unlatched) and fully open (e.g. unlocked or unlatched). It is recognized that the partially open configuration of the closure panel 6 can also include a secondary lock (e.g. closure panel 6 has a primary lock configuration at fully closed and a secondary lock configuration at partially open—for example for latches 10 associated with vehicle hoods).

In terms of vehicles 4, the closure panel 6 may be a hood, a lift gate, or it may be some other kind of closure panel 6, such as an upward-swinging vehicle door (i.e. what is sometimes referred to as a gull-wing door) or a conventional type of door that is hinged at a front-facing or back-facing edge of the door, and so allows the door to swing (or slide) away from (or towards) the opening 13 in the body 5 of the vehicle 4. Also contemplated are sliding door embodiments of the closure panel 6 and canopy door embodiments of the closure panel 6, such that sliding doors can be a type of door that open by sliding horizontally or vertically, whereby the door is either mounted on, or suspended from a track that provides for a larger opening 13 for equipment to be loaded and unloaded through the opening 13 without obstructing access. Canopy doors are a type of door that sits on top of the vehicle 4 and lifts up in some way, to provide access for vehicle passengers via the opening 13 (e.g. car canopy, aircraft canopy, etc.). Canopy doors can be connected (e.g. hinged at a defined pivot axis and/or connected for travel along a track) to the body 5 of the vehicle at the front, side or back of the door, as the application permits. It is recognized that the body 5 can be represented as a body panel of the vehicle 4, a frame of the vehicle 4, and/or a combination frame and body panel assembly, as desired.

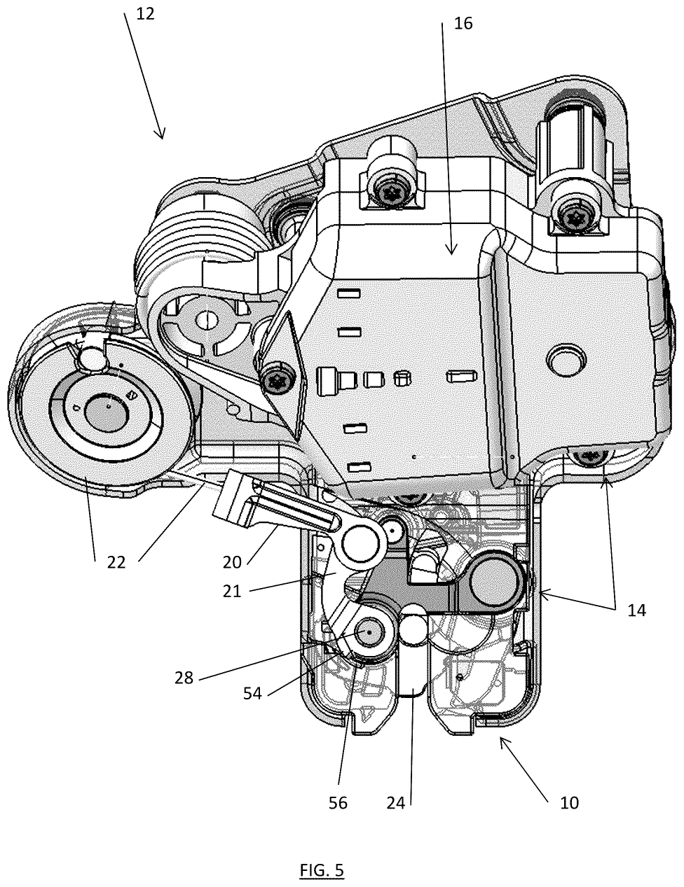

Referring to FIG. 4, shown is an example power latch assembly 12 having a frame 14, a rotary actuator system 16 (containing one or more motors/actuators 90, 92—see FIG. 7) mounted on the frame 14 and the latch 10 mounted on the frame 14. The power latch assembly 12 can be coupled to the body 5. The latch 10 is oriented on the frame 14 so as to be aligned to engage the mating latch component 7 (e.g. striker 7). The rotary actuator system 16 is coupled to a cinch member 20 (e.g. cinch arm 20) via a cinch linkage 22 (e.g. pulley and cable system as further described below) and also to one or more latch components 23 (e.g. ratchet 24 and/or pawl 25 as further described below—see FIG. 3). As such, the cinch member 20 can be actuated (e.g. pulled) by the cinch linkage 22 to operate the closure panel 6 from a partially closed position to a fully closed position, during the cinch operation, as the cinch member 20 can be coupled to the ratchet 24 via a cinch lever 21 arm. It is also recognized that the cinch linkage 22, can be provided as a rigid linkage rather than as a flexible linkage involving cables. For example, the cinch linkage 22 can be embodied as a sector gear (or other series of rigid members) connected to the cinch member 20 and/or the cinch lever 21 at one end of the cinch linkage 22 (see FIG. 5). At the other end of the cinch linkage 22, a gear 22a can be connected to an output shaft 74 that thus drives the gear 22a to move the member 20 in order to cinch the latch 10 as described.

It is recognized that the cinch member 20 (as operated by actuation of the cinch actuator/motor 90, 92) can act directly or indirectly on the ratchet 24 and/or the striker 7 in order to move the ratchet 24 from the partially closed position to the fully closed position (e.g. cinched and latched such that the pawl 25 retains the ratchet 24 in the latched position and as such the seal 6a is compressed between the closure panel 6 and the body 5). In other words, the cinch member 20 is actuated by the cinch actuator/motor 90, 92 (see FIG. 7) in order to cause the ratchet 24 to move from the partially closed to the closed position (e.g. cinched and thus latched).

Referring to FIGS. 4, 5, 6, the latch 10 includes a number of latch elements 23 (e.g. ratchet 24, cinch linkage 22, cinch member 20, cinch lever 21 and pawl 25) that are configured to cooperate with the mating latch component 7 in order to retain the mating latch component 7 within a slot 3 when the closure panel 6 (see FIG. 1a, b, c) is in the closed position (e.g. locked), or otherwise to drive the mating latch component 7 out of the slot 3 when the closure panel 6 is in the open position. The fish mouth or slot 3 is sized for receiving the mating latch component 7 therein, in other words the slot 3 of the latch 10 is configured for receiving a keeper (e.g. striker) of the mating latch component 7. The slot 3 has an open top end and a closed bottom end as shown. The latch elements 23 of the ratchet 24 and pawl 25 are pivotally secured to the frame plate 14 via respective shafts 28, 26. The ratchet 24 includes an arm 30 and an arm 32 spaced apart to define a generally u-shaped slot 103 there between (e.g. a hook of arm 30 and a lip of arm 32 that extends laterally beyond the hook). Note that in FIG. 4 the latch 10 with associated ratchet 24 are shown in the fully or primary closed position (e.g. facilitating the retention of the mating latch component 7 within the slots 3, 103).

Referring to FIG. 4, the latch components 23 can include a number of biasing elements (for example springs), such as ratchet biasing element that biases rotation of the ratchet 24 about the shaft 28 to drive the mating latch component 7 out of the slot 3 (thus moving the closure panel 6 towards the open position), pawl biasing element that biases rotation of the pawl 25 about the shaft 26 to retain the ratchet 24 in the closed position (i.e. restrict rotation of the ratchet 24 about the shaft 28 under the influence of the ratchet biasing element), cinch biasing element that can bias rotation of the cinch lever 21 towards an un-cinched position for the ratchet 24 about shaft 28 and linkage biasing element that biases return of the cinch linkage 22 towards an un-cinched position of the ratchet 24.

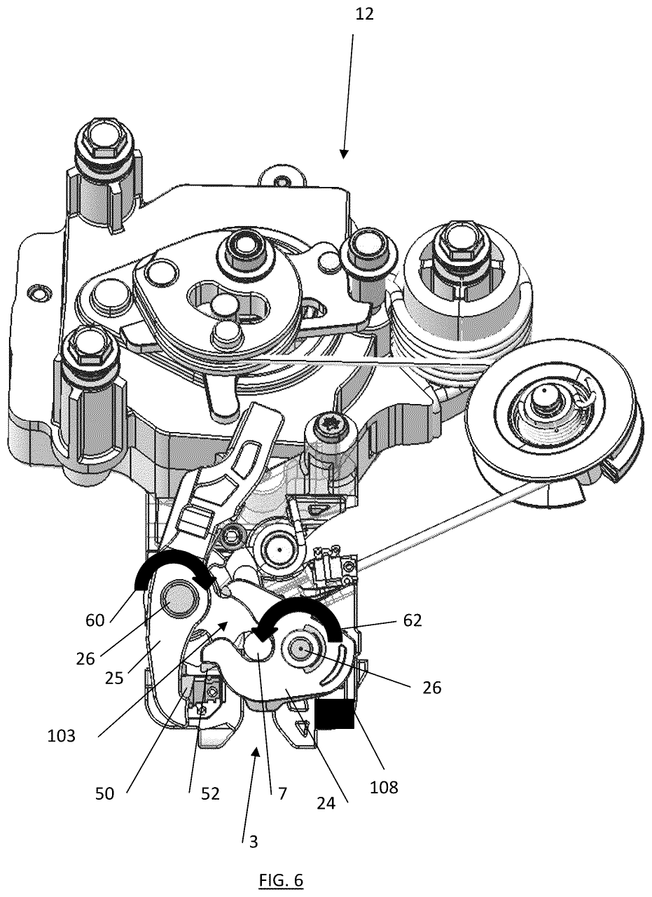

In terms of cooperation of the various latch components 23 with one another, a plurality of detents (also referred to as shoulder stops) can be employed to retain the latch components 23 in position until acted upon. For example, as can be seen in FIGS. 4,6 the ratchet 25 has a detent 50 (or shoulder stop) that mates with detent 52 (or shoulder stop) of the ratchet 24, thus retaining the ratchet 24 in the closed position. As shown in FIG. 6, rotational movement 60 of the pawl 25 about shaft 26 removes detent 50 from contact with detent 52, against the bias of pawl biasing element, thus allowing for rotational movement 62 of the ratchet 24 about the shaft 28 (e.g. under the influence of the ratchet biasing element). Rotational movement 62 results in movement of the mating latch component 7 towards the open end of the slot 3 and therefore out of the slot 103. Referring to FIG. 5, shown is detent 54 (or shoulder stop) positioned on the cinch arm lever 21 in contact with detent 56 (or shoulder stop) positioned on the ratchet 24. As such, contact between the detents 54, 56 provides for corotation of the cinch lever 21 and the ratchet 24 about the shaft 28, as further described below in relation to the cinching operation of the latch 10.

Referring to FIG. 7, the rotary actuation system 16 can include one or more motors 90, 92 positioned in the housing 14 and coupled to the drive shaft 74. A back drive biasing element can bias the cinch lever 21 (and thereby the ratchet 24) towards the un-cinched position, while operation of the motor(s) 90,92 actuate(s) the position of the ratchet 24 towards the cinched position due to corotation of the cinch lever 21 and ratchet 24 about the shaft 28. It is recognized that the position sensor 108 is used to measure the position of the ratchet 24 as it moves in relation to the output force provided by the motor(S) 90, 92. As shown by example, the rotary actuation system 16 as one example includes two electric motors 90 and 92. A control circuit 94 (e.g. representing the controller 102 of FIG. 8) controls energization of the motors 90, 92. The control circuit 94 can include, for example, a simple switch, or more complex arrangement providing pinch resistance, express open/close, etc. Motor 90 has a first rotary drive element 91 (e.g. worm gear) disposed about its output shaft 93 which engages a common rotary drive element 96 (e.g. spur gear) attached to the drive shaft 74, such that the common rotary drive element 96 drives the output shaft 74 under influence of driven rotation of one or more of the motors 90,92. It is recognized that in the event of failure of one of the motors 90,92, the other operational motor 90,92 can be used to drive the drive shaft 74 while the failed motor 90,92 remains coupled to the drive shaft 74. The output shaft 74 is provided in a driving relationship to the mechanism to be driven, e.g. the linkage system 22. The linkage system 22 can include, for example, a cable and pulley mechanism as further described below. Motor 92 has a second rotary drive element 95 (e.g. worm gear) disposed about its output shaft 97 which engages the common rotary drive element 96 (e.g. spur gear) attached to the drive shaft 74. For example, as shown in FIG. 4, the linkage system 22 can include a pulley 120 and cable 122, such that the cable 122 couples rotation of a cinch cam 110 to movement of cinch lever 21. It is recognized that the linkage system 22 could optionally include the pulley 120, as desired. For example, the cable 122 could be connected directly between the cinch cam 110 and the cinch lever 21 without an intermediate pulley or, the cable 122 could be connected indirectly between the cinch cam 110 and the cinch lever 21 via an intermediate pin or series of cable guides as is known in the art (not shown).

Referring again to FIG. 7, when both the electric motors 90 and 92 are energized via control circuit 94, drive elements 91, 95 can both independently drive the common drive element 96 and thus the drive shaft 74, thus causing the linkage system 22 to be operated and thus manipulate the attached cinch lever 21 and attached member 20. As further discussed below, manipulation of the cinch lever 21 provides for rotation of the ratchet 24 about the shaft 28 towards and into the cinched position, thus positioning the mating latch component 7 in the fully closed position in the slot 3 of the latch 10 (see FIG. 5). AS discussed herein, the position of the ratchet 24 during the conch operation is reported by the position sensor 108 to the controller 102 (see FIG. 8).

In view of the above, it is recognized that the latch 10 and associated cinching system can be embodied any number of ways (e.g. a single actuator 90, a pair of actuators 90, 92, etc.) in order to implement the example cinching calibration procedure/mode 200, 300, 400.

Referring to FIG. 8, shown is the cinch calibration system 100 as a high level block diagram showing a controller 102 (e.g. control circuit 94) which can control various actuators 104 (e.g. actuators 90, 92) based on a position of the closure panel 6 detected during cinch. Controller 102 may include circuitry for controlling the actuators, such as by controlling a current 99 supplied to the actuators. Controller 102 may include a motor controller 101 having electrical components including FETS and H-bridge for regulating the supply of the current 99 to the motor 104). Optional is a strut actuator 106 (e.g. lift gate actuator of the strut 8a) for automatically operating the closure panel 6 from a fully open position to the partially closed position (see FIGS. 3a, 3b) before implementation of the cinch operation (see FIG. 3c). A position sensor(s) 108 can be in many different forms, as further provided below by example. The position sensor(s) 108 can detect the absolute position of the ratchet 24, e.g. at one or more positions. The position sensor(s) 108 could be positioned in the latch 10 as desired. The cinch calibration system 100 can operate to know the position (between fully open and fully closed) of the ratchet 24, and thus speed, at all times. It is recognised that the fully closed position can also be referred to as a cinched position (i.e. the latch 10 is fully closed). The position sensor(s) 108, as well as controller 102, could be associated with, such as housed within for example, other types of actuators, such as a powered door actuator, such as described in WO2020252601A1 entitled “A power closure member actuation system”, the entire contents of which are incorporated herein by reference.

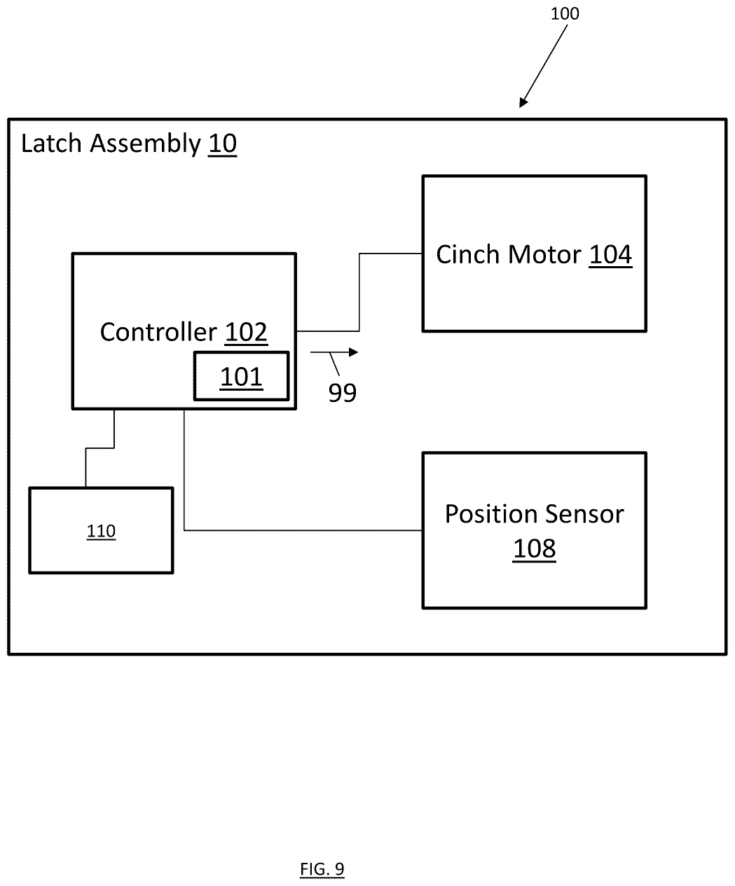

Referring to FIG. 9, shown is a further example embodiment of the cinch calibration system 100, such that the physical location of the electronics is within the latch 10 (e.g. housing 14).

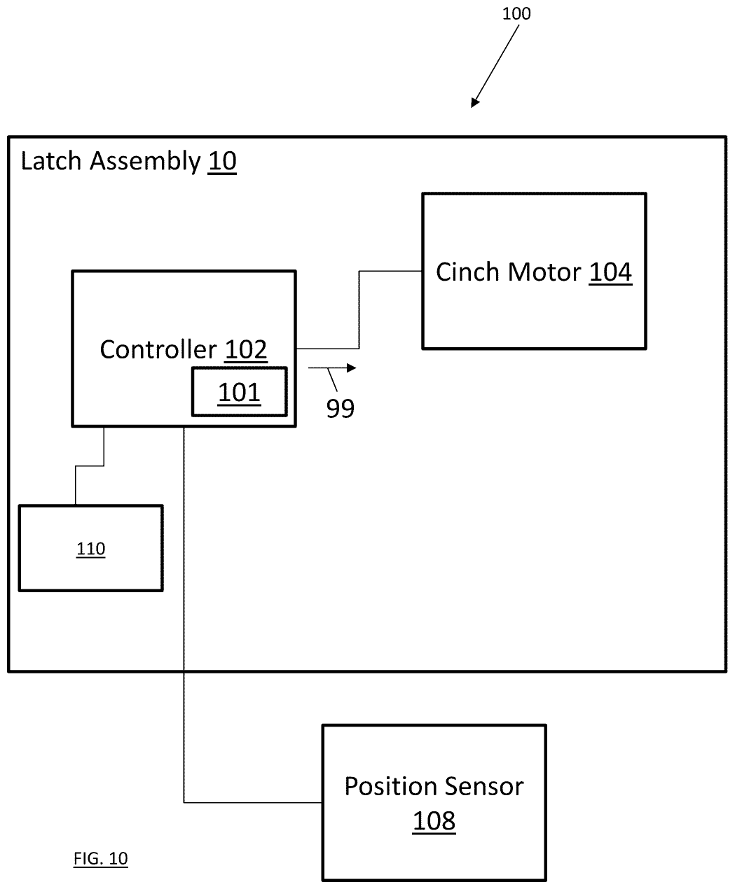

Referring to FIG. 10, shown is a further example embodiment of the cinch calibration system 100, such that the position sensor 108 can detect the closure panel 6 from a sensor external the latch 10, e.g. via hinge 8, or via powered strut 8a actuator, and thus in relation to position of the closure panel 6 the controller 102 would be able to infer or otherwise deduce the position and thus speed of the ratchet 24 at any position (e.g. zone) in the cinching cycle operation.

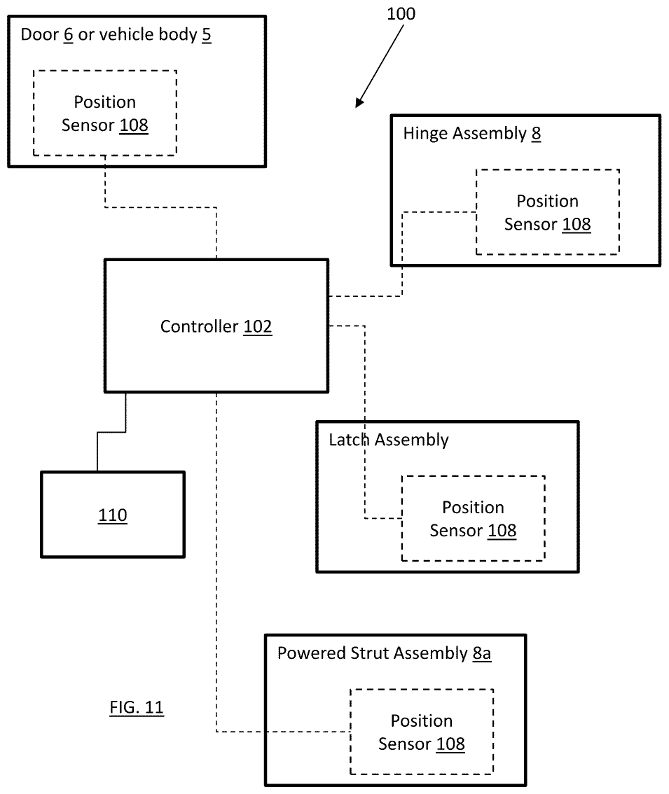

Referring to FIG. 11, shown is a further example embodiment of the cinch calibration system 100, such that there can be one or more positions of possible position sensors 108. The position sensor 108 can be positioned on the door 6 (as shown) or on the vehicle body 5, as desired. Also the position sensor 108 can be on the hinge 8 and the latch assembly 10, as well as the power strut assembly 8a.

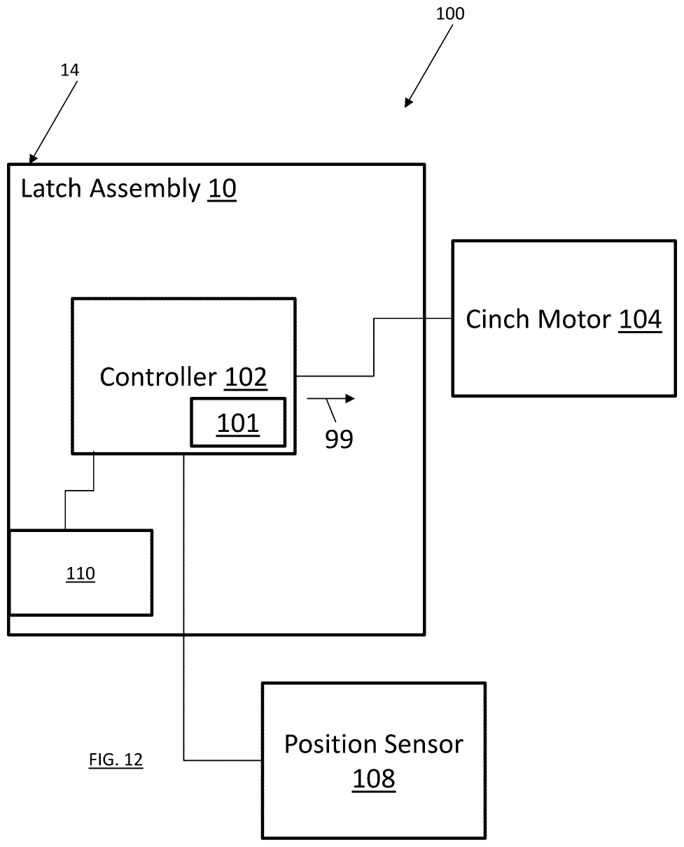

Referring to FIG. 12, shown is a further example embodiment of the cinch calibration system 100, such that the cinch functionality may be configured as a cinch motor 104 external to the housing 14 of the latch 10 (i.e. latch assembly 10).

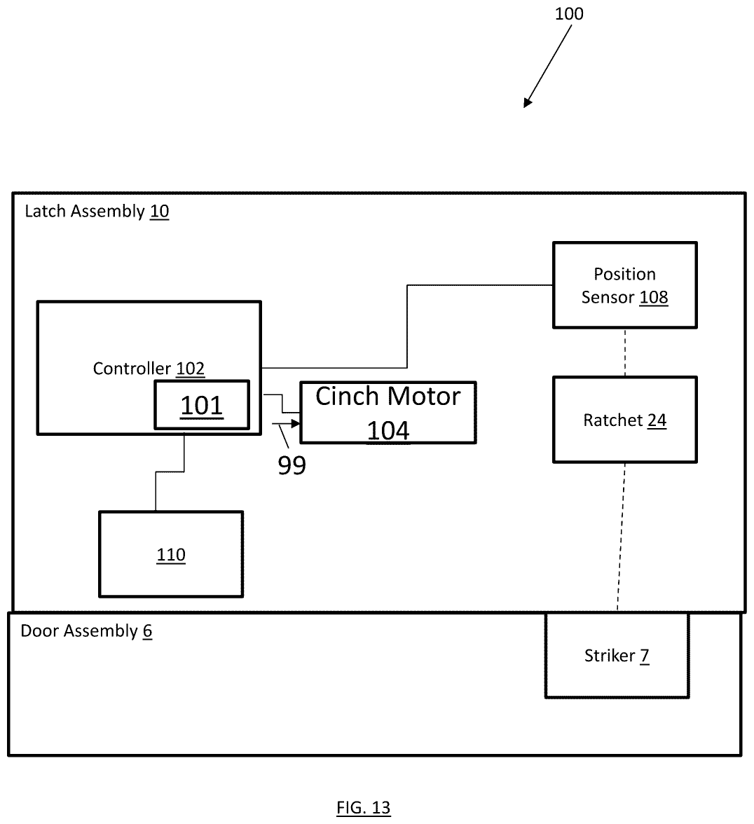

Referring to FIG. 13, shown is a further example embodiment of the cinch calibration system 100, such that the sensor 108 can be associated with the ratchet 24 to detect the position of the ratchet 24 about its pivot 28, recognizing that the ratchet 24 is coupled to the striker 7 during the cinching operation (as facilitated by the cinch actuator 104).

Referring again to FIG. 8, the controller 102 has a computer processor 102a for processing/executing a set of stored instructions, a memory 102b for storing the instructions, and an interface 102c for sending/receiving signals (e.g. voltage measurements, current measurements, resistance measurements) to and from the other components of the cinch calibration system 100 (e.g. cinch actuator(s) 104 and position sensor(s) 108).

In view of the above, it is recognised that the cinch detection system 100 can also be used to implement the cinching calibration procedure/mode 200, 300, 400 as further herein described.

Referring to FIG. 14, shown is an example embodiment method 200 of controlling the cinch actuator 104 to regulate movement of the ratchet 24 in response to detecting an improper ratchet 24 speed in a particular zone(s), i.e. the determined ratchet 24 speed does not match the set 110 calibration data. The cinch actuator 104 may be controlled to inhibit or otherwise increase/decrease speed of the ratchet 24 in response to detecting an improper speed of the ratchet 24, for example in response to an unexpected force/position in the motion of the ratchet 24. A difference in the actual position/speed of the ratchet 24 in relation to the provided applied force of the motor 104 compared to an expected/calibrated position/speed of the ratchet 24 may be an example of an improper setting of the output force of the motor 104, e.g. due to latch 10 wear, seal 6a changes, and/or changes in environmental conditions and/or improper motion of the closure panel 6 due to a pinching event for a finger/obstacle 2.

Referring again to FIG. 14, shown is an example operation 200 of the cinch calibration system 100 of FIG. 8. At step 202 the controller 102 activates the cinch motor 104 during closing the closure panel 6 from partially closed to fully closed, for example using the latch 10 and cinch member 20 of FIG. 2. At step 204 the controller 102 monitors the position/speed of the ratchet 24 (either directly of indirectly) via the sensor(s) 108 during the cinch operation. At step 206, the controller 102 receives signal(s) from the position sensor(s) 108 and determines that the position/speed of the ratchet 24 (in view of the applied force) does not match the calibration data 110 (e.g. the controller 102 compares actual position/speed of the ratchet 24 to a set 110 (see FIG. 8) of calibrated position/speed of the ratchet 24). At step 208, the cinch operation would be stopped if the controller 102 determines that the position/speed of the ratchet 24does not match the set 110 of measurements and instead indicates that a pinch event may have occurred (e.g. determined that a foreign object 2 is impeding the closure panel movement 6 such that the movement of the position/speed of the ratchet 24 does not correspond with movement/operation of the cinch actuator 104). Otherwise, at step 209, the motor 104 force is adjusted by the controller 102 for the particular zone under consideration in order to change the respective speed of the ratchet 24 in an attempt to match the respective zone predetermined/stored speed in the calibration data 110. After step 209, the method repeats at step 204 for the next zone in the cinch cycle operation. In the event, when all zones have been encountered (e.g. the latch 12 is fully closed), then the cinch calibration system 100 ends at step 210 when the last zone is completed.

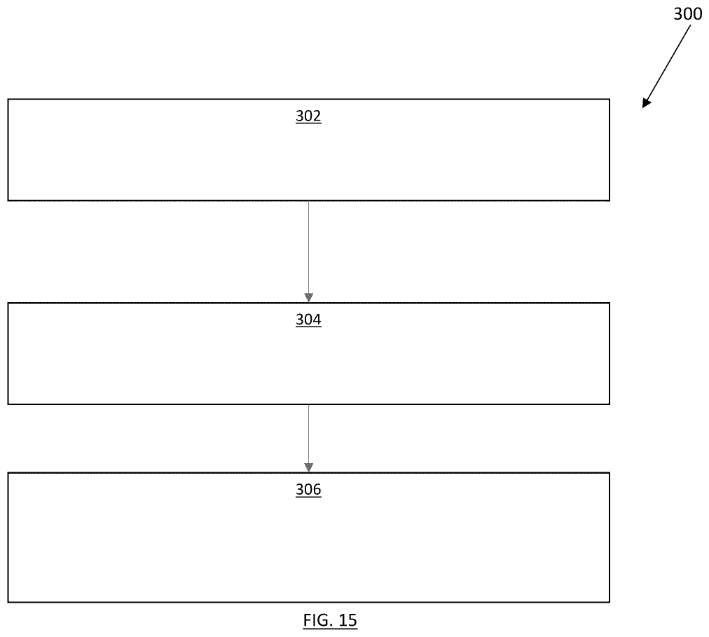

Referring to FIG. 15, shown is an alternative example embodiment method 300 of controlling the cinch actuator 104 to regulate movement of the ratchet 24 in response to detecting an improper ratchet 24 speed in a particular zone(s), i.e. the determined ratchet 24 speed does not match the set 110 calibration data. At step 302 the cinch motor 104 output force is controlled using stored output force parameters by the controller 102 for a given cinch zone. At step 304, the performance of the cinch operation is monitored based on measured/determined speed(s) of the ratchet 24 as compared to the calibration data 110. At step 306, the motor 104 output force is adjusted in order to change the ratchet speed 24 when such speed is determined to be outside of the speed ranges (e.g. for each zone) in the calibration data 110, in order to maintain cinch performance within a performance range. In the event that it is determined by the controller 102 that the changed motor 104 output force succeeded in bringing the ratchet 24 speed (for the respective zone) back within the predetermined speed ranges/targets, then that new/changed motor 104 output force is stored in the calibration data 110 for that respective zone. In this manner, it is anticipated that application of the new/changed motor 104 output force for that zone in the next cinch cycle should result in the proper speed of the ratchet 24 (i.e. to fall within the predetermined zone speeds stored in the calibration data 110 for the ratchet 24). If in the next cinch cycle the new/changed motor 104 output force (now stored in the calibration data 110 for the motor 110) does not result in the appropriate speed of the ratchet 24 (as also stored in the calibration data 110 for the ratchet 24), then the motor 104 output force is further changed/modified (e.g. up or down) by the controller 102 in an effort by the controller 102 to bring the ratchet 24 speed to within the desired speed range of the zone stored in the calibration data 110.

Referring to FIG. 16, shown are calibration data 110a representing the desired speed ranges 110c of the ratchet 24 for each of the zones 110d (e.g. consecutive portions of the cinch operation travel of the ratchet 24 from partially closed to fully closed state of the latch system 12). For example, zone 1 represents the portion of the ratchet 24 travel from the partially closed (e.g. secondary position) state of the latch system 12, i.e. at the beginning of the cinch operation. For example, zone 10 represents the portion of the ratchet 24 travel to the fully closed (e.g. primary position) state of the latch system 12, i.e. the last zone at the end of the cinch operation. In one example operation, is used as seen in the table throughout the entire zone. Further, it is recognized that cinch motor force targets can be adjusted incrementally after each cinch cycle. Example target values can range from 55 Nm to 150+ Nm in increments of 5 or more Nm. Example target values can be referred to as are calibration data 110a representing the stored motor 104 force output for each of the zones 110d. Further, speed targets preferably to remain consistent during each of the cinch cycles.

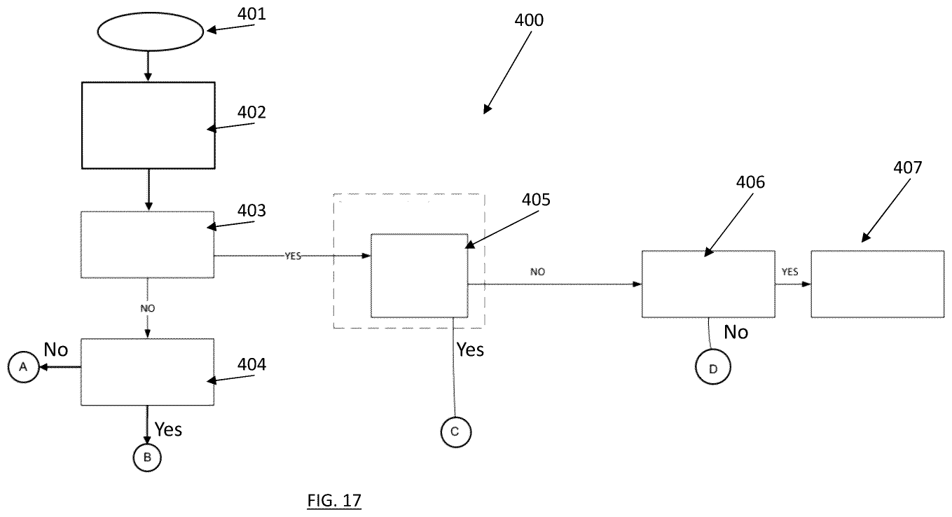

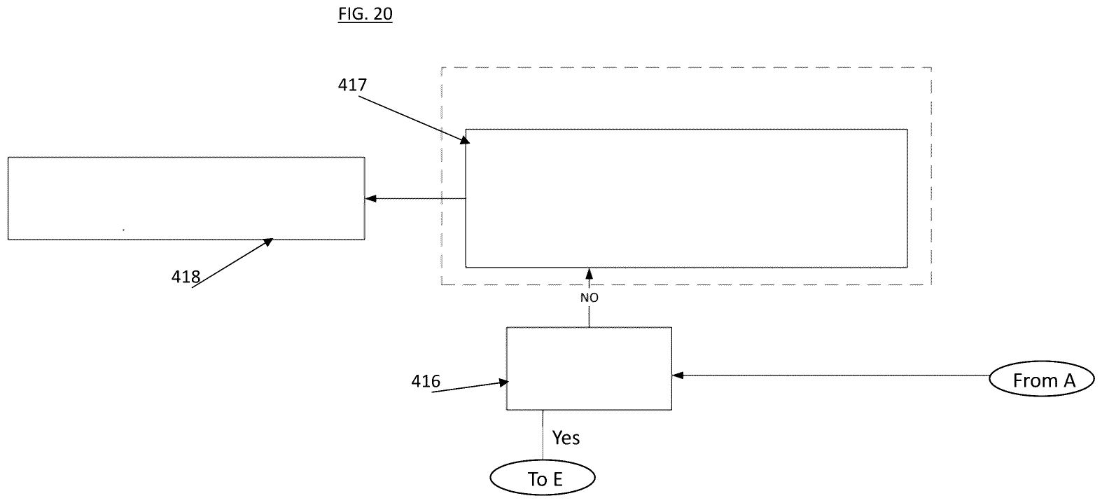

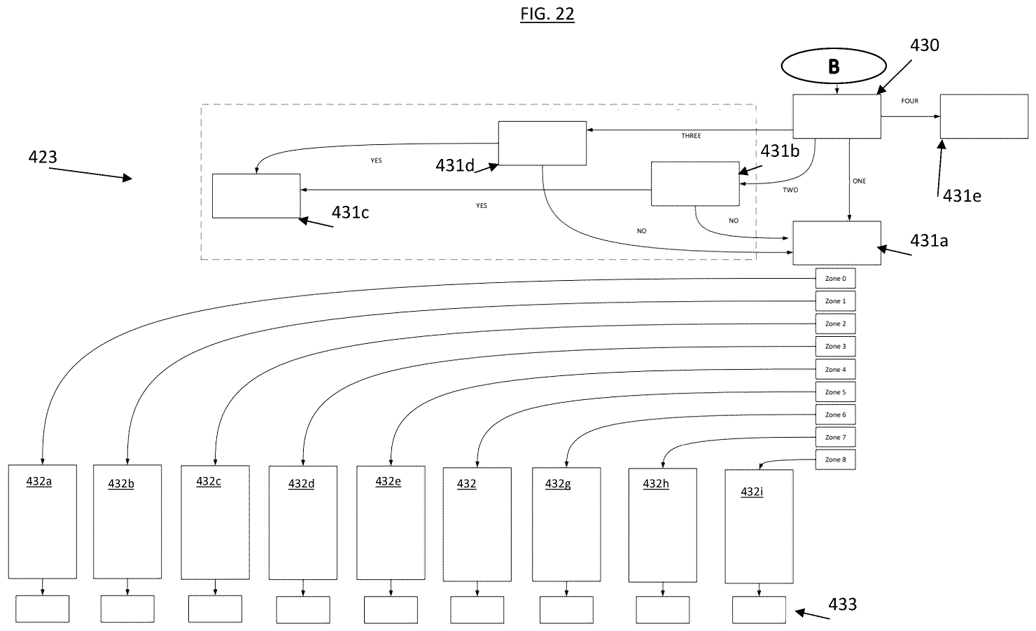

Referring to FIGS. 17, 18, 19, 20, 21, 22, shown is a fine tuning method 400 as a further embodiment to that of the methods 200, 300 of FIGS. 14,15. Within this method 400, the cinch cycle is completed successfully within accepted performance ranges, but the performance is approaching the boundaries of the accepted performance ranges which causing a cinch stop signal (due to over speed or under speed conditions detected of the ratchet 24). The cinching parameters are obtained from the stored calibration data 110 (see FIGS. 16a,16b for example), as accessed by the controller 102 during the cinch calibration system 100 operation. At step 401, the method 400 is started at the beginning of the cinch operation of the latch system 12. At step 402, the controller 102 operates the motor 102 using the calibration data 110b (e.g. the ratchet zonal speed targets. At step 403, the controller 102 checks if the latch system 12 reached the fully closed and thus latched position. If NO, then at step 404 the controller 102 decides if an obstacle 2 was involved in stopping the cinching process. If YES then procedure B is followed (see FIG. 22), otherwise if NO then procedure A is followed (see FIG. 20). For procedure A, the cinching may be stopped due to ratchet 24 detected to be over speed targets. To inhibit high speed of the ratchet 24 which translates to high pinch forces, the cinch cycle will stop and the cinch forces can be adjusted to reduce the over speed condition during cinch.

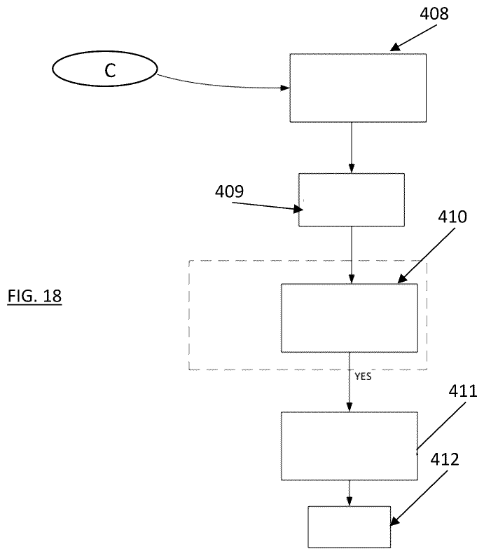

If at step 403 the latch system 12 YES did reach the fully closed and thus latched position, then at step 405 the controller 102 can check if speeds in any of the zones were above the average (e.g. midrange also referred to as upper quartile (75-100%) of the stored speed target). If YES, then procedure C can be followed (see FIG. 18). For example, if speed is higher in some zones, adjustments can optionally be made by the controller 102 to lower ratchet 24 speed after the cinch cycle is complete in order to bring the ratchet 24 speed into a desired (e.g. normal) performance range (e.g. upper/lower Q range as given by example in FIG. 16). Higher speeds could be due to changes in seal condition, changes in friction, such as change in ratchet grease amount, misalignment in striker, changes in actuator performance in certain cinching zones, etc.

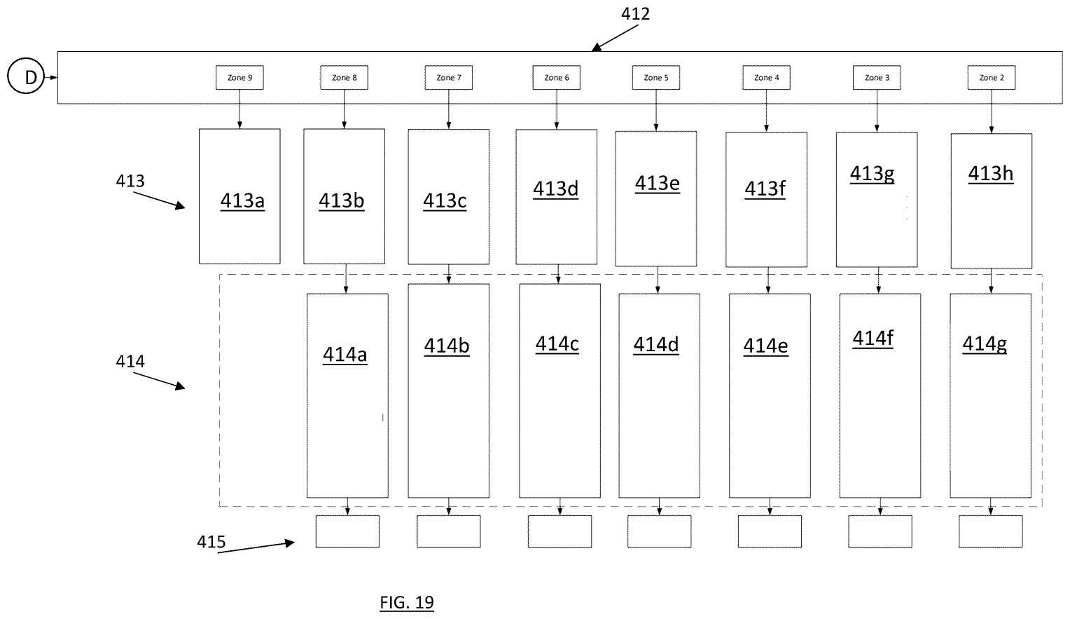

Alternatively if NO at step 405, then the controller 102 checks at step 406 if the ratchet 24 in all zones reached their specified speed targets in the calibration data 110. If YES, then step 407 is followed (i.e. no further action is needed). Otherwise if NO at step 406, then procedure D is followed (see FIG. 19). Under speed zones can be adjusted by the controller 102 after a successful cinch cycle has completed, for example.

Referring to FIG. 18, for procedure C, optionally if for a particular zone the target speed is determined to be in the upper speed target range, the motor 104 force output targets (e.g. motor current) can be reduced by the controller 102 for that zone in an effort to reduce the momentum energy of the ratchet 24 (and thus resultant speed). For example, at step 408, adjustment actions for current zones affected by a speed increase is done by the controller 102 such that a decrease in output force of the motor 104 in a zone with higher speed is implemented, e.g. for the first zone identified—both the previous zone and the current zone are decreased by level 1. Step 409 checks for a potential cascade of the decreases as needed. For example in step 410, adjustment to later zones is performed, as identified: Since there may be a cascade effects on the later zones due to the previous decreased speed adjustment, (decreasing speed in an earlier zone may also case a reduction in speed), if some later zones are already experiencing a slowdown, the later zones are sped up so that there are no false obstacle detection (under speed or stall condition) on the next cycle due to the decrease in speed during the tuning process causing itself the obstacle detection. For example, if you reduce the speed in previous zones, the next zones, even if there are no changes in their behavior, can cause the ratchet 24 to slow to a point of triggering a false obstacle due to sufficient momentum in the previous slows being lowered due to the reduced speed. If YES at step 410 for after zones, then at steps 411, 412 there is implemented an adjustment check: The increase in speed is preferably not excessive and follows a rule that the speed of a previous zone cannot be greater than zone current. In other words step 411 is for the desired increase (i.e. the opposite result of step 408) and step 412 is the opposite result of step 409.

Referring to FIG. 19, procedure D is outlined by example. For zones detected to be below expected target speed, the controller 102 increases these underspeed zones by adjusting the cinch motor 104 force output to compensate for variations in the environment from one cinch cycle to the next. At step 412 each zone is checked (e.g. what is the first zone identified where the speed target was not reached). At step 413, each respective zone speed increases are made to correspond to adjacent zones, i.e. increases in speed within a zone would include increases in speed within neighboring zones. For example, if Zone 9 was detected, then increases 413a (e.g. Level 1) are applied to Zones 8 and 9. For example, if Zone 8 was detected, then increases 413b (e.g. Level 1) are applied to Zones 7, 8 and 9. For example, if Zone 7 was detected, then increases 413c (e.g. Level 1) are applied to Zones 6, 7 and 8. For example, if Zone 6 was detected, then increases 413d (e.g. Level 1) are applied to Zones 5, 6 and 7. For example, if Zone 5 was detected, then increases 413e (e.g. Level 1) are applied to Zones 4, 5 and 6. For example, if Zone 4 was detected, then increases 413f (e.g. Level 1) are applied to Zones 3, 4 and 5. For example, if Zone 3 was detected, then increases 413g (e.g. Level 1) are applied to Zones 2, 3 and 4. For example, if Zone 2 was detected, then increases 413h (e.g. Level 1) are applied to Zones 1, 2 and 3.

Then at step 414 for each respective zone, the controller 102 checks if subsequent zones are withing speed target, because we are increasing forces to help provide that the system is not over speed in next cycle which could cause an over speed stop condition. For example, for Zone 9, the zone is checked to see if it has achieved at least 25% or higher of the speed target. In other words, for this zone, the previous zone is decreased by level 2 and the current zone is decreased by level 1 at step 414a. For example, for Zones 8 to 9, the zones are checked to see what the first zone is that has achieved at least 25% or higher of the speed target. In other words, for these zones, the previous zone is decreased by level 2 and the current zone is decreased by level 1 at step 414b. Similar operations 414c, d, e, f, g are performed for Zones 7 to 9, Zones 6 to 9, Zones 5 to 9, Zones 4 to 9, Zones 3 to 9 respectively. Step 415 provides for the checking and implementation confirmations of the cascade-decrease. The controller 102 verifies if the next zones have been monitored to be already in a top speed performance range and reduce the motor 104 output in these zones as the speed will increases already without motor 104 adjustment required.

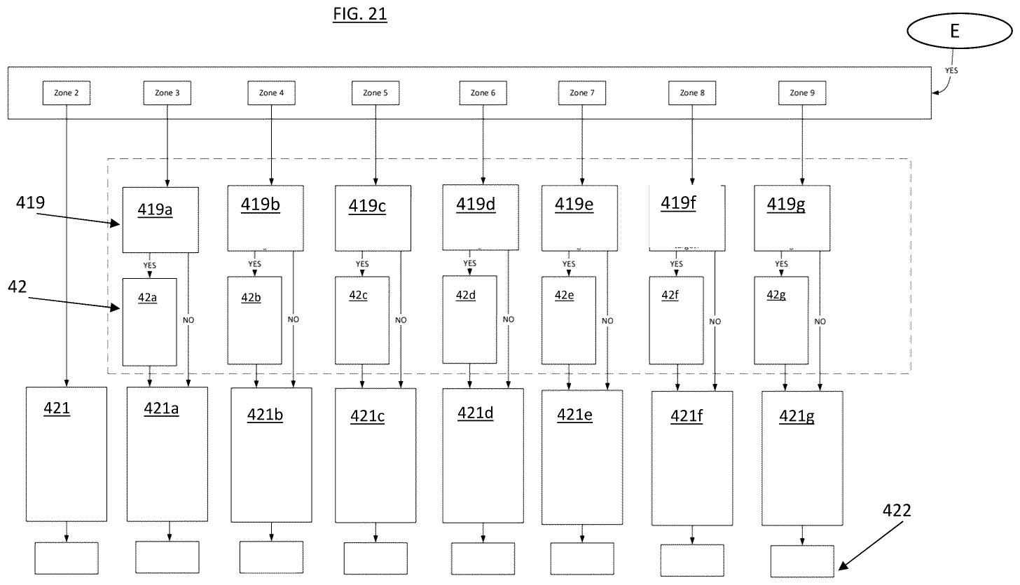

Referring to FIG. 20, procedure A is outlined by example. At step 416, cinch stop reason is checked (e.g. was it stopped due to the speed being over target speed). If YES then procedure E is followed (see FIG. 21). If NO, then steps 417,418 are done. For example, at step 417 for zones 6 to 9, check if cinching stopped due to speeds increasing as opposed to be within speed targets OR did cinching stop due to speed being at least 1.3 greater than the zone starting speed within that zone (e.g. only for zones 6-9). Next at step 418, cascading is performed as discussed previously (e.g. use the average of the adjacent two zone values added to the previous zone—(Z6+Z5)/2+Z5 value is added to all later zones). Basically the middle value is found between zones 5,6 and this value is out in all later zones 6-9, for example. Sensitivity to speed in these zones as part of the later portion of the cinch operation can decrease (i.e. the seal 6a resistance is starting to become significant in resisting the travel of the closure panel 6), so speed increases in these zones can be monitored specifically.

In FIG. 21, the controller 102 follows procedure E, in an effort to determine which of the zones the speed overshot the stored speed target range on the calibration data 110, on a zone by zone basis. Steps 419, 42, the controller 102 checks if previous zone was not overspeed, but close to the upper range also.

For example, for Zone 2, the zone is checked 419a to see if it has achieved at least 75% or higher of the speed target. Similarly at 419b Zones 2-3 are checked, at 419c Zones 2-4 are checked and so on for steps 419c, d, e, f, g.

At step 42a, for the first zone identified, if yes, the previous zone is decreased by the previous level and the current zone is decreased by the current level. Similarly for each of the steps 42b, c, d, e, f, g. For step 419a for example, if no, the previous zone 2 is decreased by level 5 and the current zone 3 is decreased by level 5 at result 421a, while the remaining zones 4-9 remain unchanged. For step 419b for example, if no, the previous zone 3 is decreased by level 5 and the current zone 4 is decreased by level 5, while the remaining zones 5-9 remain unchanged at result 421b. Similar logic is applied to steps 42c, d, e, f, g with results 421c, d, e, f, g. It is noted that result 421 is provided for Zone 2, without having to go through steps 419, 42 methodologies.

Step 422 provides for the checking and implementation confirmations of the cascade-decrease. In other words, at steps 42a, b, c, d, e, f, g and 421,421a, b, c, b, e, f, g, 422, the controller 102 decreases the cinch force of the motor 104 during subsequent zones as programmed.

In FIG. 22, the controller 102 follows procedure B, in order to determine if stopped a subsequent time, the motor 104 forces are increased in that particular zone of interest to adjust for any suspected specific zone (non-obstacle) behaviors. Procedure B involves a number of steps 423 for each of the zones in order to determine for the first cinch cycle stopped depending on which zone, the forces can be increased to provide that the stop of the cinch process was not due to an environmental source acting on all zones (non-obstacle source).

For example, step 430 checks to see how many cycles in a row (e.g. in adjacent cycles) has an obstacle been detected. For one cycle, at step 431a the particular zone detected is identified. For two cycles, at step 431b it is checked if the second obstacle was in the same zone or the next zone as the previous obstacle. If NO then step 431a is followed. If YES, then at step 431c the previous zone and the current zone are increased by a level 4 CASCADE-INCREASE.

For three cycles, at step 431d it is checked if the third obstacle was in the same zone or the next zone as the first obstacle. If NO then step 431a is followed. If YES, then at step 431c the previous zone and the current zone are increased by a level 4 CASCADE-INCREASE. For four cycles, at step 431e the system waits for user action to continue.

At step 431a, each zone 0-8 is checked with the corresponding increase speed result 432a, b, c, d, e, f, g, h, i provided. For example, result 432i provides for zone 7 to level 4, zone 8 to level 4 and zone 9 to level 4. For example, result 432h provides for zone 6 to level 6, zone 7 to level 4 and zones 8,9 to level 3. For example, result 432g provides for zone 5 to level 6, zone 6 to level 4 and zones 7,8,9 to level 3. Similar logic can be provided for results 432a, b, c, d, e, f. Step 433 provides for the checking and implementation confirmations of the cascade-increase.

The various illustrative logical blocks, modules, and circuits described in connection with the embodiments disclosed herein (e.g. the controller 102, the control circuit 94, etc.) can be implemented or performed with a general purpose processor, a digital signal processor (DSP), an ASIC, a FPGA or other programmable logic device, discrete gate or transistor logic, discrete hardware components, or any combination thereof designed to perform the functions described herein. A general purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

Processors suitable for the execution of a computer program (e.g. including the set 110 of calibration data as well as any of the steps shown in FIGS. 14, 15, 17-22, stored in a computer memory) include, by way of example, both general and special purpose microprocessors, and any one or more processors of any kind of digital computer. Generally, a processor will receive instructions and data from a read-only memory or a random access memory or both. The essential elements of a computer are a processor for executing instructions and one or more memory devices for storing instructions and data. Generally, a computer will also include, or be operatively coupled to receive data from or transfer data to, or both, one or more mass storage devices (i.e. computer memory) for storing data, e.g., magnetic, magneto-optical disks, or optical disks. Information carriers suitable for embodying computer program instructions and data include all forms of non-volatile memory, including by way of example, semiconductor memory devices, e.g., electrically programmable read-only memory or ROM (EPROM), electrically erasable programmable ROM (EEPROM), flash memory devices, and data storage disks (e.g., magnetic disks, internal hard disks, or removable disks, magneto-optical disks, and CD-ROM and DVD-ROM disks). The processor and the memory can be supplemented by, or incorporated in special purpose logic circuitry.

Those of skill in the art would understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Those of skill would further appreciate that the various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of claims exemplified by the illustrative embodiments. A software module may reside in random access memory (RAM), flash memory, ROM, EPROM, EEPROM, registers, hard disk, a removable disk, a CD-ROM, or any other form of storage medium known in the art. An exemplary storage medium is coupled to the processor such the processor can read information from, and write information to, the storage medium. In the alternative, the storage medium may be integral to the processor. In other words, the processor and the storage medium may reside in an integrated circuit or be implemented as discrete components.

Computer-readable non-transitory media (e.g. computer memory) includes all types of computer readable media, including magnetic storage media, optical storage media, flash media and solid state storage media. It should be understood that software can be installed in and sold with a central processing unit (CPU) device. Alternatively, the software can be obtained and loaded into the CPU device, including obtaining the software through physical medium or distribution system, including, for example, from a server owned by the software creator or from a server not owned but used by the software creator. The software can be stored on a server for distribution over the Internet, for example.

We claim:

1. A system (100) for calibrating a cinch operation of a latch system (12) coupled to a closure panel (6) of a vehicle (4), the system comprising:
an actuator (104) for moving the closure panel from a partially closed position to a closed position using a series of applied forces;
one or more sensors (108) for sensing positions of a ratchet (24) of the latch system in response to each of the series of applied forces, said each of the series of applied forces provided in a respective zone of a series of zones; and
a controller (102) for determining a respective speed of the ratchet in each of the respective zones based on the sensed positions and for comparing each of the respective speeds to a set of calibration data (110) containing one or more predetermined speeds of the ratchet for each of the respective zones of the series of zones;
wherein based on said comparing, the controller adjusts one or more of the series of applied forces in order to adjust one or more of the respective speeds of the ratchet.

2. The system of claim 1, wherein the one or more position sensors include a hall sensor positioned adjacent to the ratchet.

3. The system of claim 2, wherein said each of the respective zones of the series of zones has a corresponding speed range of the ratchet stored in the calibration data.

4. The system of claim 1, wherein said determining of the respective speed of the ratchet in said each of the respective zones is scheduled by the system for multiple times over an operational lifetime of the latch system.

5. The system of claim 1 further comprising the controller identifying differences in the respective speeds in all of the respective zones based on said comparing and as a result determining that the closure panel has encountered an obstacle.

6. The system of claim 5, wherein the controller determines based on the differences that a variation in the environment has occurred if the obstacle was not encountered.

7. The system of claim 5, wherein the controller determines if the obstacle was encountered in the same or different zone in adjacent cycles of the cinch operation.

8. The system of claim 1, wherein the controller determines if the cinch operation was stopped due to a speed of the rachet being greater than one of the one or more predetermined speeds.

9. The system of claim 1, wherein the controller determines if the cinch operation was stopped due to a speed of the rachet being less than one of the one or more predetermined speeds.

10. A latch comprising:
a ratchet for retaining a striker coupled to a closure panel of a vehicle in a primary striker capture position and a secondary striker capture position; and
a motor, the motor adapted to move the ratchet during a cinch operation to move the striker from the secondary striker capture position to the primary striker capture position to move the closure panel from a partially opened position to a fully closed position;
wherein the motion of the ratchet is monitored during the cinch operation and the motor is operated during a subsequent cinch operation based on the monitored motion of the ratchet during the cinch operation.

11. A method (200,300,400) for calibrating a cinch operation of a latch system coupled to a closure panel of a vehicle, the method comprising the steps of:
operating an actuator for moving the closure panel from a partially closed position to a closed position using a series of applied forces;
receiving from one or more sensors a plurality of signals for sensing positions of a ratchet of the latch system in response to each of the series of applied forces, said each of the series of applied forces provided in a respective zone of a series of zones;
determining a respective speed of the ratchet in each of the respective zones based on the sensed positions;
comparing each of the respective speeds to a set of calibration data containing one or more predetermined speeds of the ratchet for each of the respective zones of the series of zones; and
based on said comparing, adjusting one or more of the series of applied forces in order to adjust one or more of the respective speeds of the ratchet.

12. The method of claim 11, wherein the one or more position sensors include a hall sensor positioned adjacent to the ratchet.

13. The method of claim 12, wherein said each of the respective zones of the series of zones has a corresponding speed range of the ratchet stored in the calibration data.

14. The method of claim 11, wherein said determining of the respective speed of the ratchet in said each of the respective zones is scheduled by the system for multiple times over an operational lifetime of the latch system.

15. The method of claim 11 further comprising a controller identifying differences in the respective speeds in all of the respective zones based on said comparing and as a result determining that the closure panel has encountered an obstacle.

16. The method of claim 15, wherein the controller determines based on the differences that a variation in the environment has occurred if the obstacle was not encountered.

17. The method of claim 15, wherein the controller determines if the obstacle was encountered in the same or different zone in adjacent cycles of the cinch operation.

18. The method of claim 11, wherein a controller determines if the cinch operation was stopped due to a speed of the rachet being greater than one of the one or more predetermined speeds.

19. The method of claim 11, wherein a controller determines if the cinch operation was stopped due to a speed of the rachet being less than one of the one or more predetermined speeds.

20. The method of claim 11, wherein the latch system includes a latch comprising:
the ratchet for retaining a striker coupled to a closure panel of a vehicle in a primary striker capture position and a secondary striker capture position; and
a motor, the motor adapted to move the ratchet during the cinch operation to move the striker from the secondary striker capture position to the primary striker capture position to move the closure panel from the partially opened position to the fully closed position;
wherein the motion of the ratchet is monitored during the cinch operation and the motor is operated during a subsequent cinch operation based on the monitored motion of the ratchet during the cinch operation.
